(19) United States
(12) Patent Application Publication
(10) Pub. No.: US 2025/0007393 A1
(43) Pub. Date: Jan. 2, 2025

(54) POWER CONVERTING APPARATUS, MOTOR DRIVE APPARATUS, AND REFRIGERATION-CYCLE APPLICATION DEVICE

(71) Applicant: Mitsubishi Electric Corporation, Tokyo (JP)

(72) Inventors: Tomohiro KUTSUKI, Tokyo (JP); Hajime TOYODA, Tokyo (JP); Koichi ARISAWA, Tokyo (JP); Takaaki TAKAHARA, Tokyo (JP); Haruka MATSUO, Tokyo (JP)

(21) Appl. No.: 18/694,713

(22) PCT Filed: Nov. 25, 2021
(86) PCT No.: PCT/JP2021/043275

§ 371 Date: Mar. 22, 2024

(51) Int. Cl. H02M 1/34; H02M 1/32; H02M 3/156; H02M 7/537

(52) U.S. Cl. CPC H02M 1/34; H02M 1/327; H02M 3/156; H02M 7/537

(57) ABSTRACT

A power converting apparatus includes: an inverter that is a power converting unit including switching elements and generating desired power by switching the switching elements; current detecting units detecting a current flowing through the power converting unit; and snubber circuits reducing a surge voltage generated by a switching operation of the switching elements. Circuits each including the switching elements and the current detecting unit are circuits to be protected by the snubber circuits, and the snubber circuits and the circuits to be protected are connected such that an internal inductance of a circuit consisting of the snubber circuit and the circuit to be protected is smaller than an external inductance.

### CROSS-REFERENCE TO RELATED APPLICATION

This application is a U.S. National Stage Application of PCT/JP2021/043275 filed on Nov. 25, 2021, the contents of which are incorporated herein by reference.

### FIELD

The present disclosure relates to a power converting apparatus that converts alternating-current power into desired power, a motor drive apparatus, and a refrigeration-cycle application device.

### BACKGROUND

A power converting apparatus that converts alternating-current power into desired power is applied to a device such as an air conditioner, and generates alternating-current power having a voltage suitable for the operation of the device. The alternating-current power is generated by a circuit including a plurality of switching elements turning on or off each switching element. A surge voltage is generated when the switching elements are turned on or off. Therefore, it is necessary to take measures to prevent the elements constituting the circuit from being destroyed by the surge voltage. For example, a power converting apparatus configured to reduce a surge voltage by using a snubber circuit is described in Patent Literature 1.

### PATENT LITERATURE

Patent Literature 1: Japanese Patent Application Laid-open No. 2012-210153

There is a case where a shunt resistor is used as an element constituting a power converting apparatus for the purpose of detecting a current flowing through a circuit. Similarly to other resistor elements, the shunt resistor also consumes power. Therefore, a loss is caused proportional to the amount of power consumption. Since the power consumption amount is proportional to a resistance value, the loss can be reduced by making the value of the shunt resistor as small as possible. However, when the resistance value is reduced, a detection voltage, that is, a difference in potential across the shunt resistor is reduced and tolerance to noise is lowered. As a result, a problem arises where accuracy of current detection is lowered. For this problem, generally, a shunt resistor having a large rated power is mounted, or shunt resistors are mounted in parallel with each other to reduce a loss per shunt resistor. However, these countermeasures lead to an increase in the cost and size of the apparatus.

### SUMMARY

The present disclosure has been made in view of the above, and an object of the present disclosure is to obtain a power converting apparatus capable of reducing or preventing an increase in the size of the apparatus.

To solve the above problems and achieve an object, a power converting apparatus according to the present disclosure includes: a power converting unit including a switching element and generating desired power by switching the switching element; a current detecting unit detecting a current flowing through the power converting unit; and a snubber circuit reducing a surge voltage generated by a switching operation of the switching element, wherein a circuit including the switching element and the current detecting unit is a circuit to be protected by the snubber circuit, and the snubber circuit and the circuit to be protected are connected such that an internal inductance of a circuit consisting of the snubber circuit and the circuit to be protected is smaller than an external inductance.

The power converting apparatus according to the present disclosure can acquire an effect capable of reducing or preventing an increase in the size of the apparatus.

### DETAILED DESCRIPTION

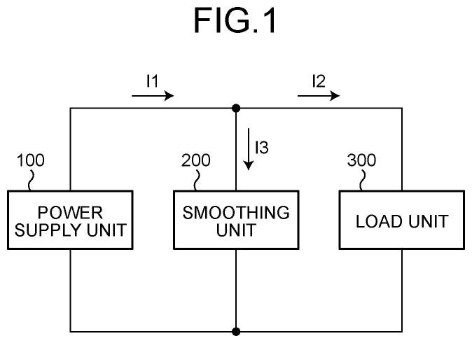

FIG. 1 is a diagram illustrating a schematic configuration of a power converting system that is realized by applying a power converting apparatus according to a first embodiment.

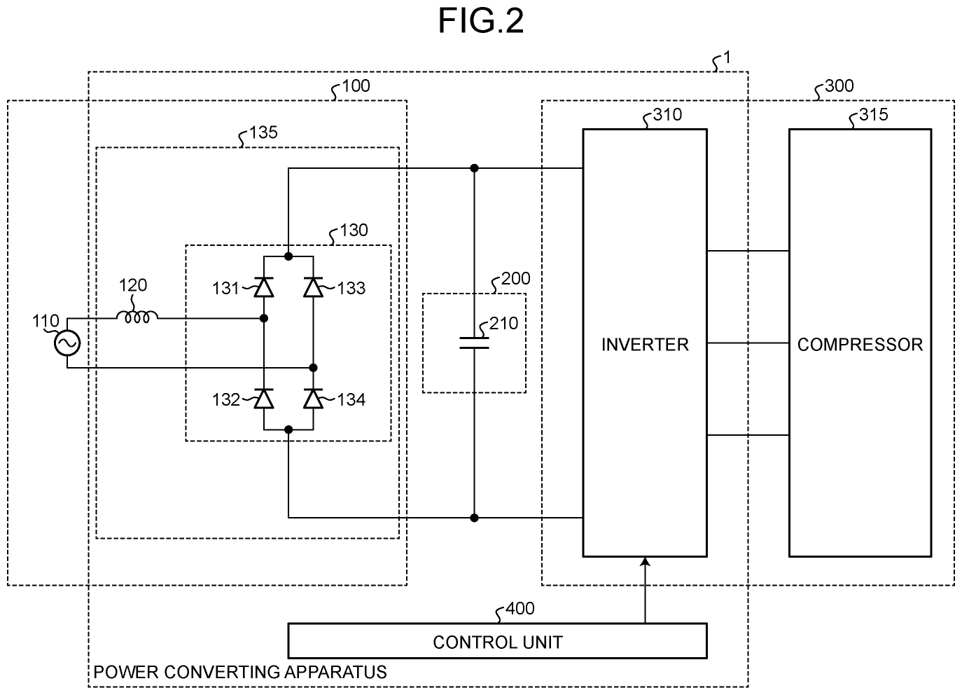

FIG. 2 is a diagram illustrating a configuration example of the power converting apparatus according to the first embodiment.

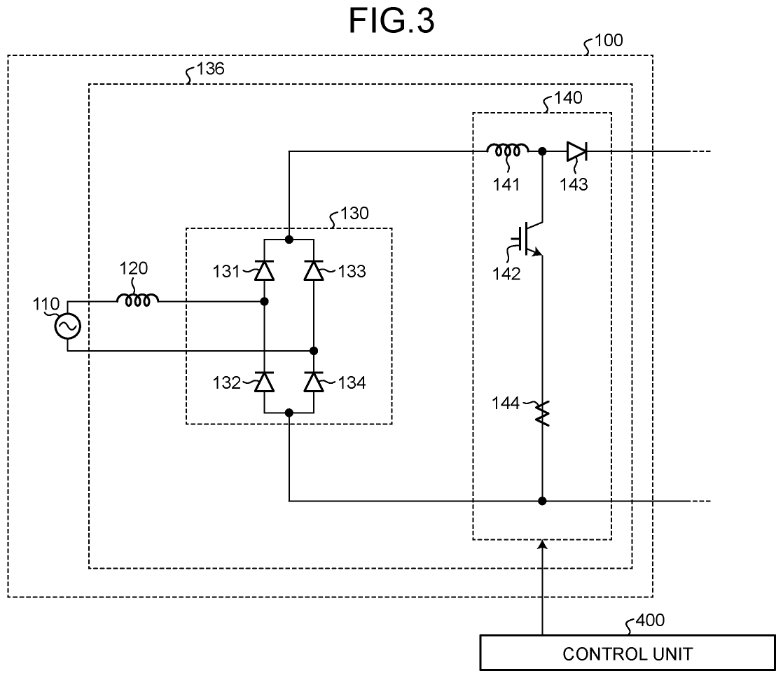

FIG. 3 is a diagram illustrating another configuration example of a power supply unit.

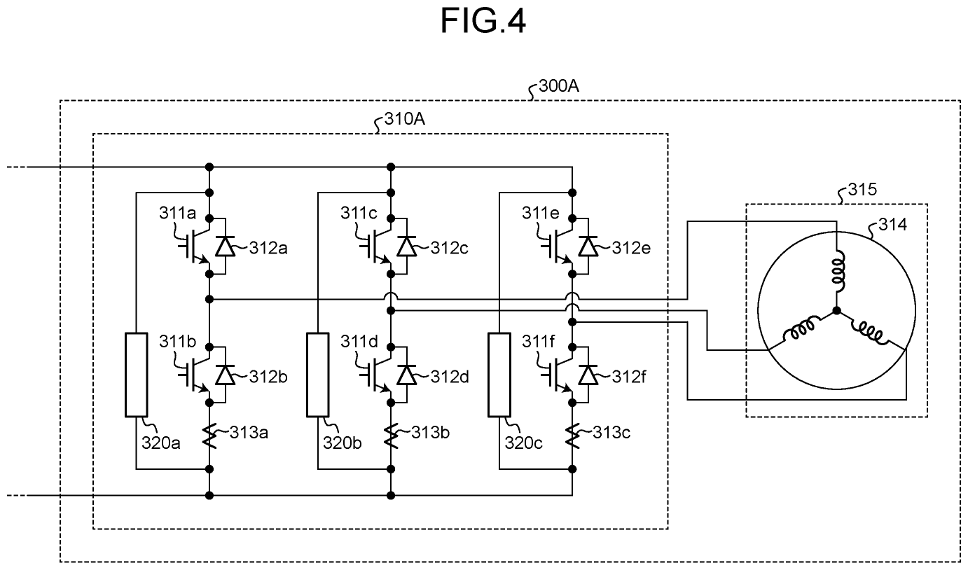

FIG. 4 is a diagram illustrating a first configuration example of a load unit included in the power converting system according to the first embodiment.

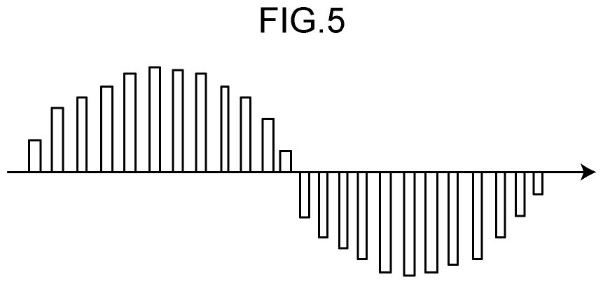

FIG. 5 is a diagram illustrating an example of a waveform of a current flowing through each leg constituting an inverter of the power converting apparatus 1.

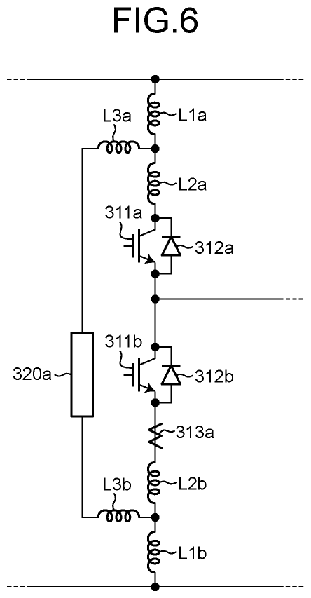

FIG. 6 is a diagram for describing details of an inverter of a first configuration example included in the power converting apparatus according to the first embodiment.

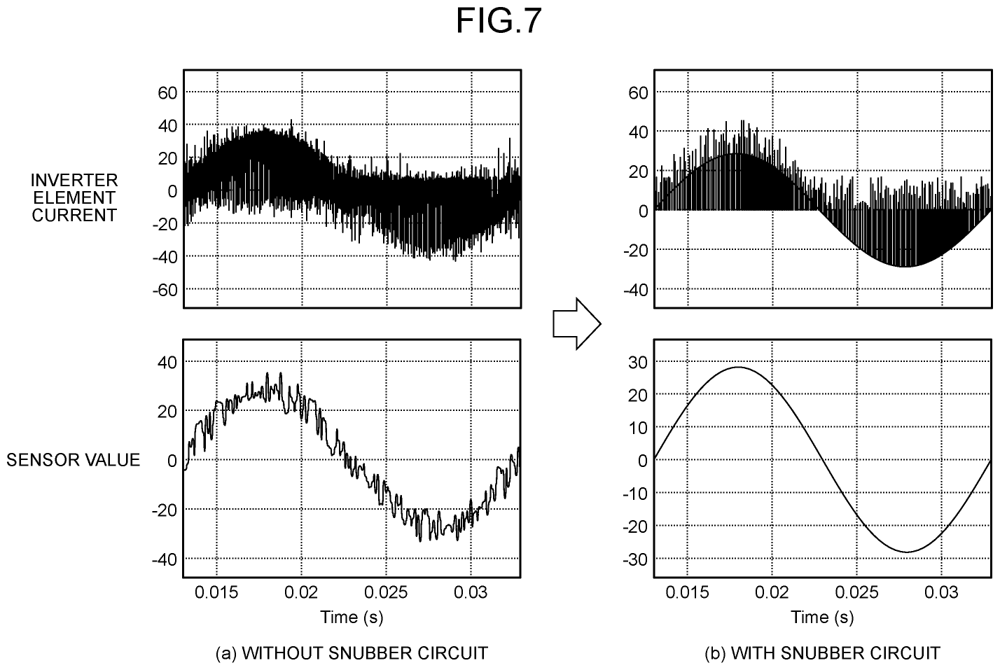

FIG. 7 is a diagram illustrating an effect obtained by the power converting apparatus according to the first embodiment.

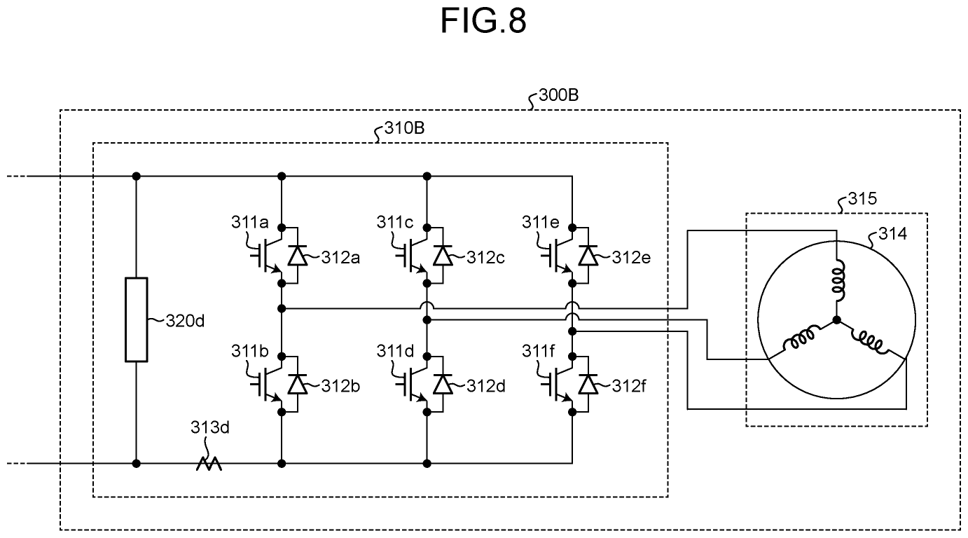

FIG. 8 is a diagram illustrating a second configuration example of the load unit included in the power converting system according to the first embodiment.

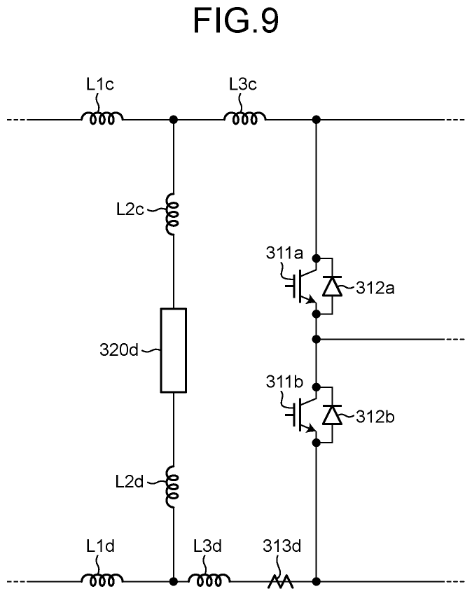

FIG. 9 is a diagram for describing details of an inverter of the second configuration example included in the power converting apparatus according to the first embodiment.

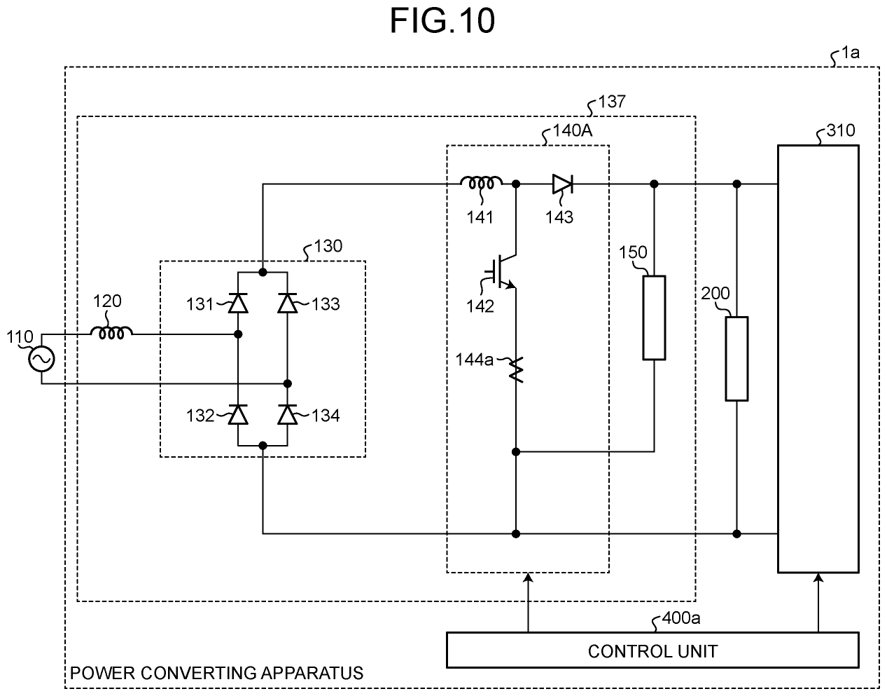

FIG. 10 is a diagram illustrating a configuration example of a power converting apparatus according to a second embodiment.

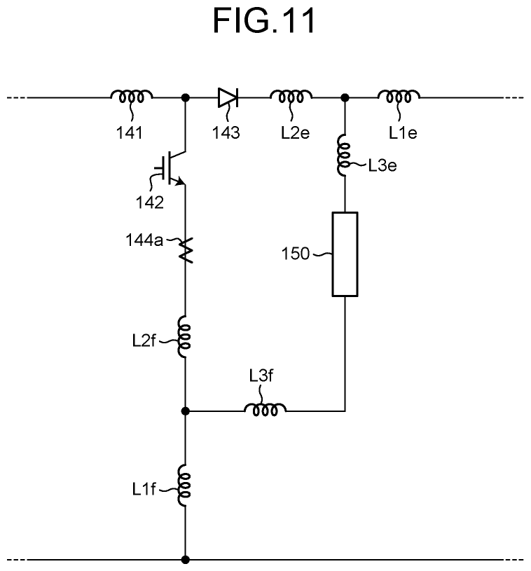

FIG. 11 is a diagram for describing an arrangement of a snubber circuit of the power converting apparatus according to the second embodiment.

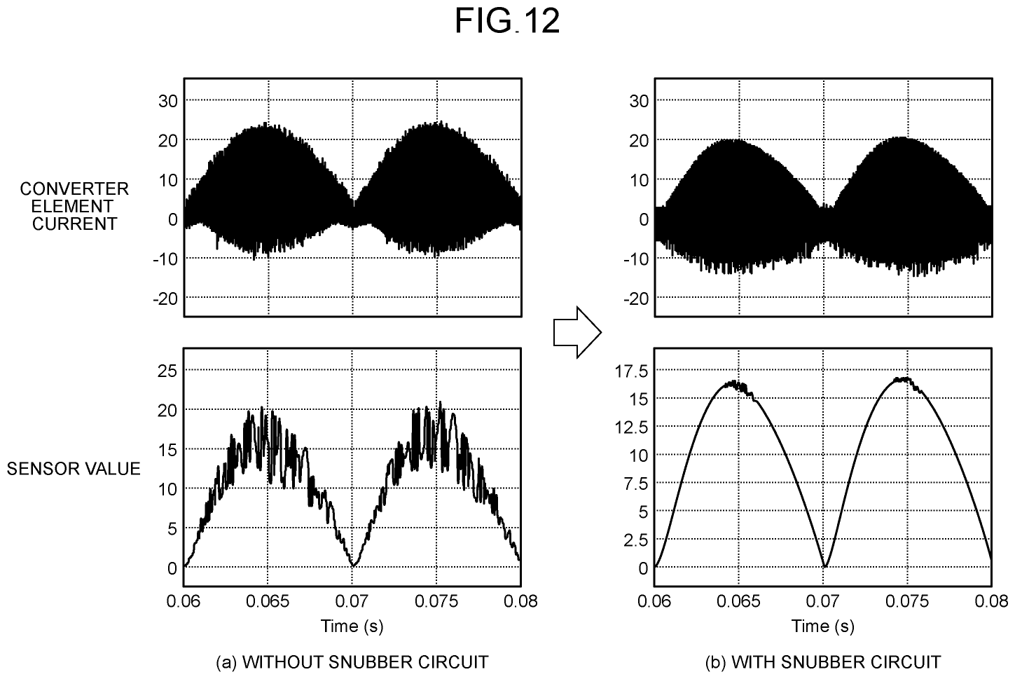

FIG. 12 is a diagram illustrating an effect obtained by the power converting apparatus according to the second embodiment.

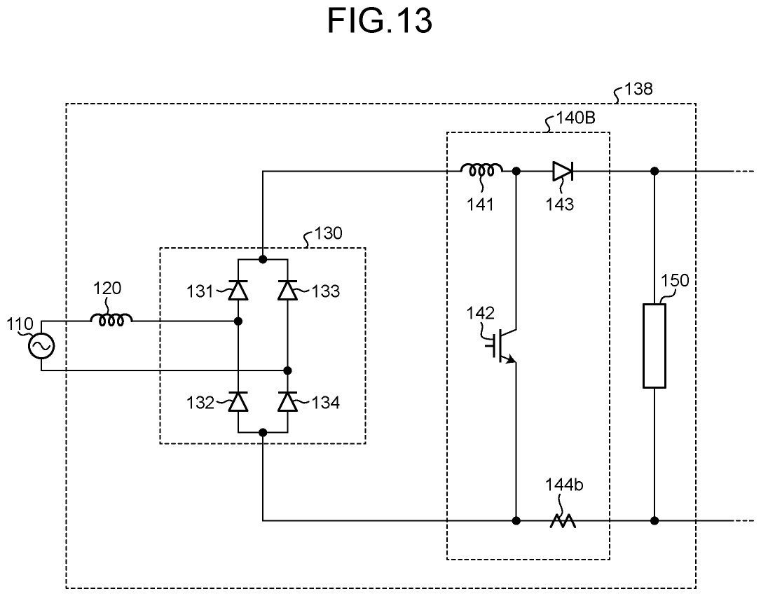

FIG. 13 is a diagram illustrating another configuration example of the power converting apparatus according to the second embodiment.

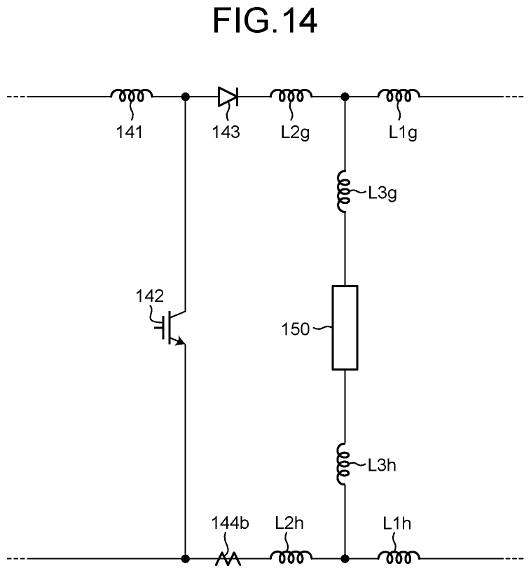

FIG. 14 is a diagram for describing details of a booster unit of another configuration example included in the power converting apparatus according to the second embodiment.

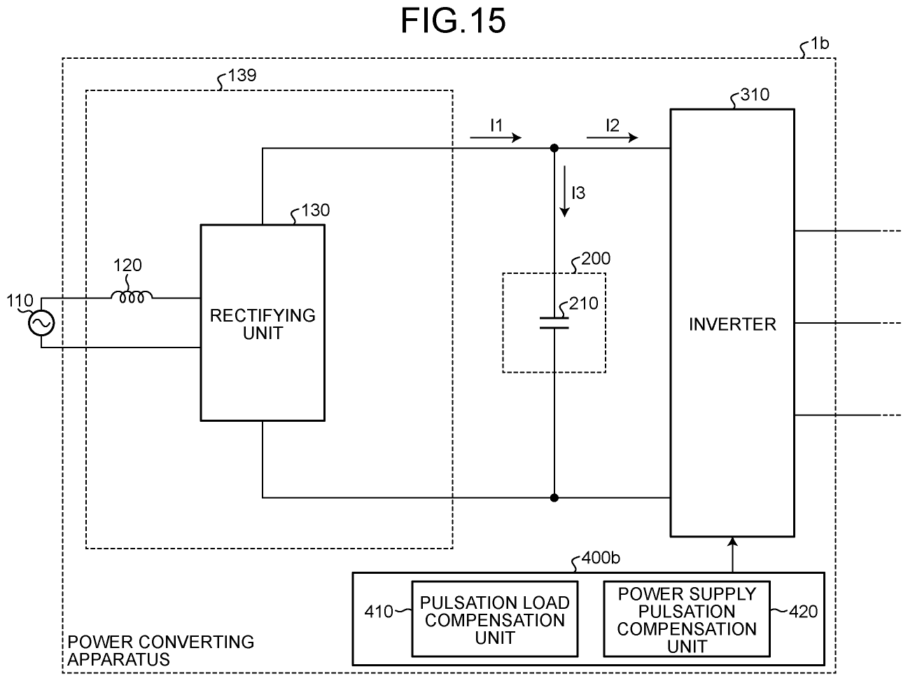

FIG. 15 is a diagram illustrating a configuration example of a power converting apparatus according to a third embodiment.

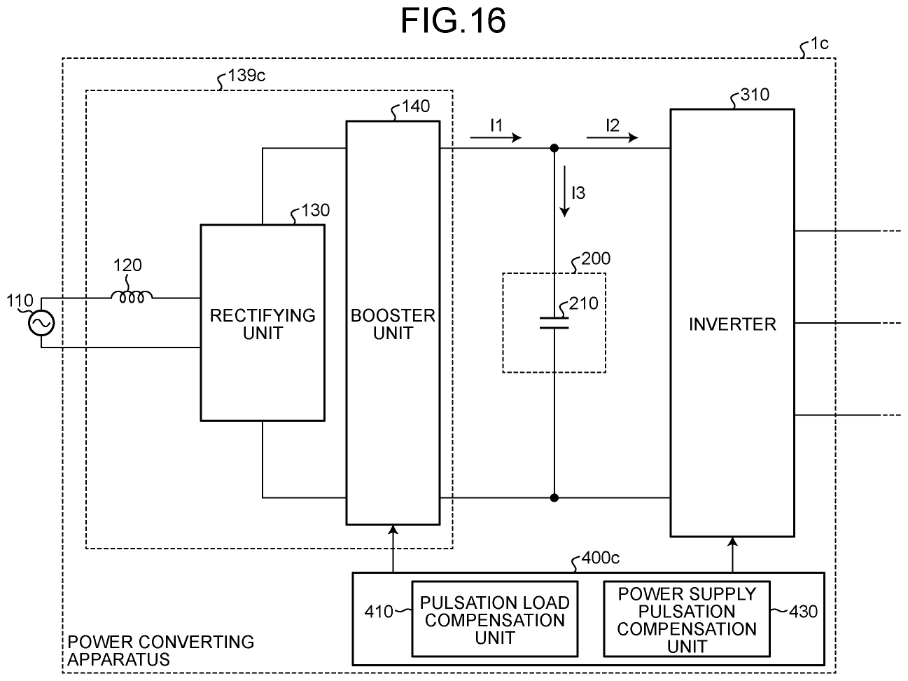

FIG. 16 is a diagram illustrating another configuration example of the power converting apparatus according to the third embodiment.

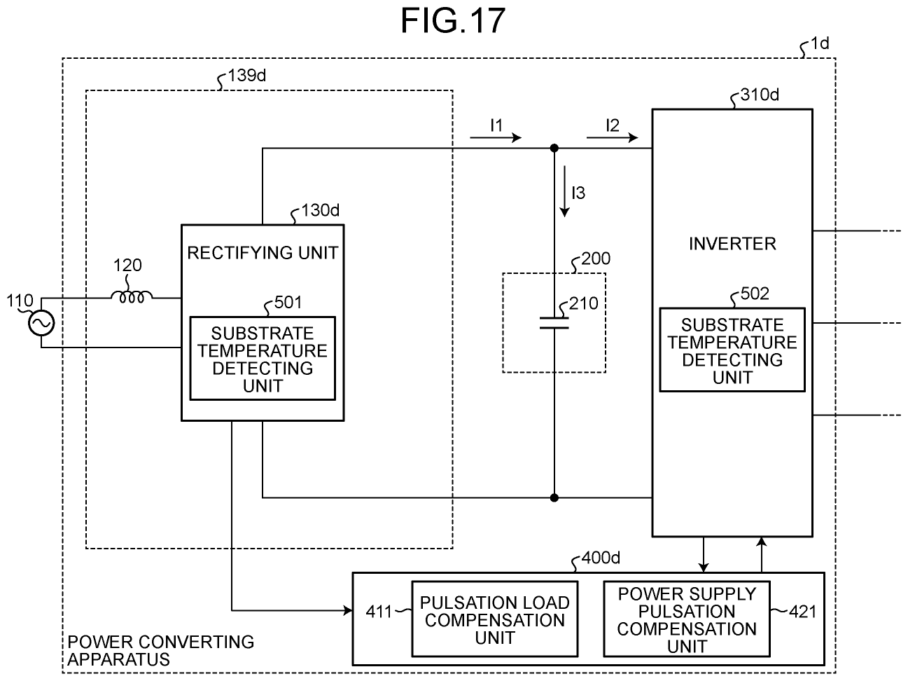

FIG. 17 is a diagram illustrating a configuration example of a power converting apparatus according to a fourth embodiment.

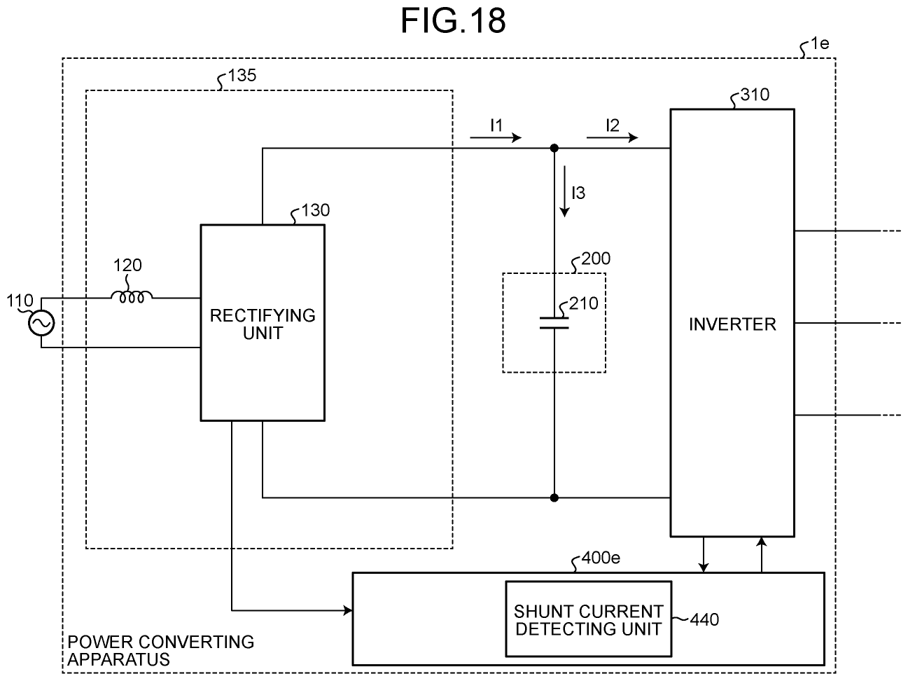

FIG. 18 is a diagram illustrating a configuration example of a power converting apparatus according to a fifth embodiment.

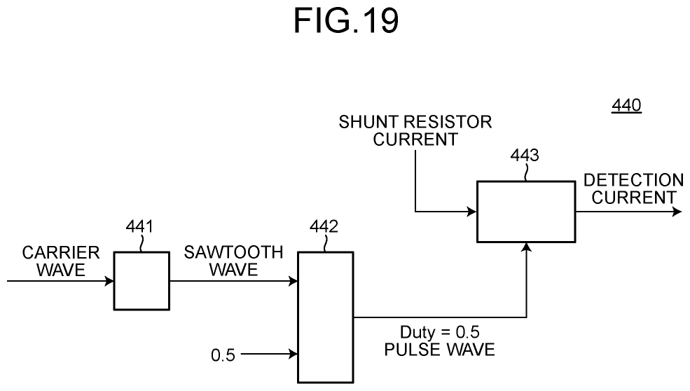

FIG. 19 is a diagram illustrating an example of a processing block configuration of a shunt current detecting unit included in the power converting apparatus according to the fifth embodiment.

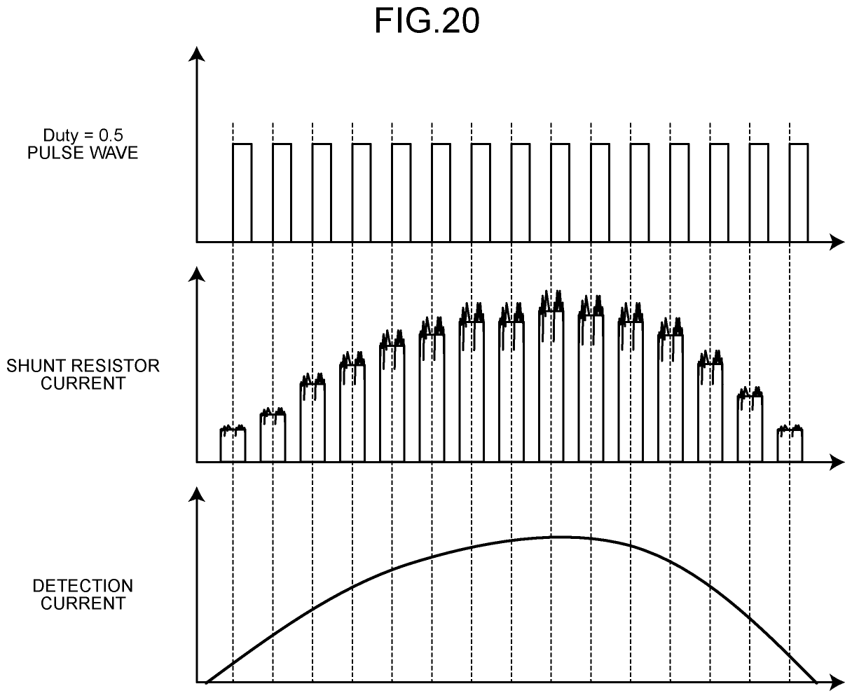

FIG. 20 is a diagram illustrating examples of operation waveforms of the shunt current detecting unit.

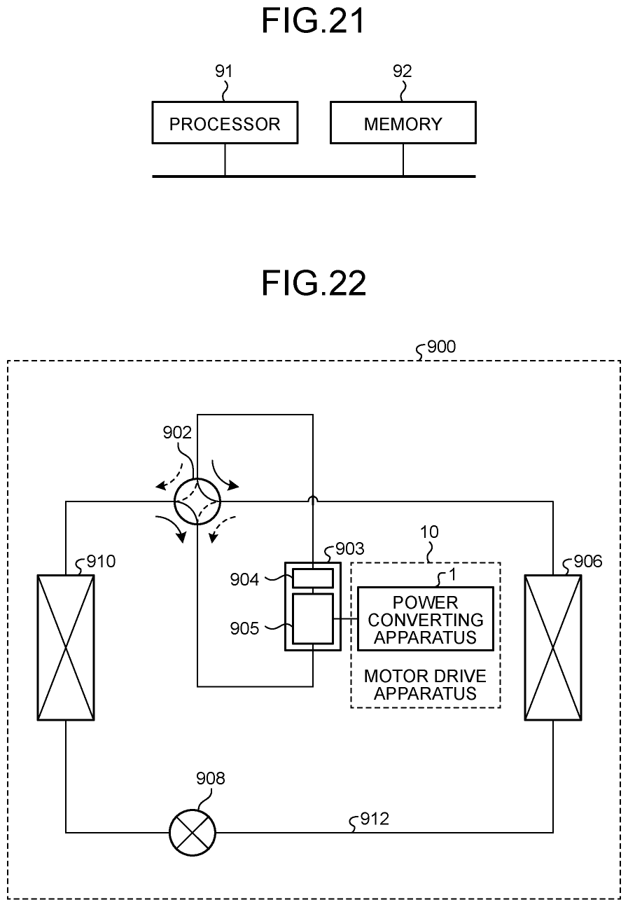

FIG. 21 is a diagram illustrating an example of a hardware configuration that implements a control unit included in the power converting apparatus.

FIG. 22 is a diagram illustrating a configuration example of a refrigeration-cycle application device according to a sixth embodiment.

### DESCRIPTION OF EMBODIMENTS

Hereinafter, a power converting apparatus, a motor drive apparatus, and a refrigeration-cycle application device according to embodiments of the present disclosure will be described in detail with reference to the drawings.

### First Embodiment

FIG. 1 is a diagram illustrating a schematic configuration of a power converting system that is realized by applying a power converting apparatus according to a first embodiment. As illustrated in FIG. 1, the power converting system according to the first embodiment includes: a power supply unit 100 including a commercial power supply, a rectifier circuit, and the like; a smoothing unit 200 including a smoothing element such as an electrolytic capacitor or the like; a load unit 300 including a motor; an inverter that drives the motor, and the like. Note that a current flowing from the power supply unit 100 toward the smoothing unit 200 and the load unit 300 is denoted by I1, a current flowing into the load unit 300 is denoted by I2, and a current flowing into the smoothing unit 200 is denoted by I3.

In the power supply unit 100, alternating-current power supplied from an alternating-current power supply, such as a commercial power supply, is rectified by a rectifier circuit. The rectified power is output to the smoothing unit 200. The smoothing unit 200 smooths direct-current power, which is the rectified power output from the power supply unit 100. The smoothed direct-current power is output to the load unit 300, and is consumed by the motor constituting the load unit 300.

FIG. 2 is a diagram illustrating a configuration example of a power converting apparatus 1 according to the first embodiment. The power converting apparatus 1 is connected to an alternating-current power supply 110, such as a commercial power supply, and a compressor 315. The power converting apparatus 1 converts first alternating-current power supplied from the alternating-current power supply 110 into second alternating-current power having a desired amplitude and phase, and supplies the second alternating-current power to the compressor 315. The compressor 315 is, for example, a hermetic compressor applied to an air conditioner, and is equipped with a motor.

The power converting apparatus 1 includes a reactor 120, a rectifying unit 130, the smoothing unit 200, an inverter 310, and a control unit 400. The rectifying unit 130 includes a bridge circuit consisting of rectifiers 131 to 134, and generates direct-current power by rectifying the first alternating-current power supplied from the alternating-current power supply 110. The reactor 120 and the rectifying unit 130 constitute a converter 135. Note that the converter 135 and the alternating-current power supply 110 constitute the power supply unit 100 of the power converting system illustrated in FIG. 1.

The direct-current power generated by the rectifying unit 130 is smoothed by the smoothing unit 200. The smoothing unit 200 includes a smoothing capacitor 210. The direct-current power smoothed by the smoothing unit 200 is supplied to the inverter 310, and is converted into the second alternating-current power for driving the compressor 315. Although not illustrated in FIG. 2, the inverter 310 includes a plurality of switching elements. The control unit 400 controlling on or off of the switching elements included in the inverter 310, and the direct-current power supplied from the smoothing unit 200 is converted into the second alternating-current power having a desired amplitude and phase. The inverter 310 operates as a power converting unit that generates desired power by switching the switching elements. Note that the inverter 310 and the compressor 315 constitute the load unit 300 of the power converting system illustrated in FIG. 1.

The configuration of the power supply unit 100 is not limited to that illustrated in FIG. 2. For example, as illustrated in FIG. 3, the power supply unit 100 may have a configuration including a converter 136 instead of the converter 135. FIG. 3 is a diagram illustrating another configuration example of the power supply unit 100. The converter 136 included in the power supply unit 100 illustrated in FIG. 3 is a single switch boost chopper circuit, and has a configuration in which a booster unit 140 is added downstream of the rectifying unit 130 of the converter 135 illustrated in FIG. 2. The booster unit 140 includes a reactor 141, a switching element 142, and a diode 143, and operates while turning on or off the switching element 142 to improve a power factor. The switching element 142 is controlled to be turned on or off by the control unit 400. Furthermore, the booster unit 140 includes a current detecting unit 144 connected in series with the switching element 142. Note that a power circuit for improving factor having a configuration different from that of the booster unit 140 illustrated in FIG. 3 may be applied as the booster unit 140.

By setting the capacitance of the capacitor of the smoothing unit 200 to a relatively large capacitance, the voltage supplied to the load unit 300 can be a substantially constant direct-current voltage.

Returning to the description of FIG. 2, the configuration of the load unit 300 can be, for example, the configuration of a load unit 300A illustrated in FIG. 4. FIG. 4 is a diagram illustrating a first configuration example of the load unit 300 included in the power converting system according to the first embodiment.

The load unit 300A of the first configuration example illustrated in FIG. 4 includes an inverter 310A and the compressor 315.

The inverter 310A corresponds to the inverter 310 illustrated in FIG. 2, and is connected to the smoothing unit 200, that is, connected across the smoothing capacitor 210, not illustrated in FIG. 4. The inverter 310A converts the smoothed direct-current power supplied from the smoothing unit 200 into the second alternating-current power, and supplies the second alternating-current power to the motor 314 included in the compressor 315.

When the compressor 315 is a hermetic compressor used for an air conditioner, a load torque is approximately constant, and the hermetic compressor can be regarded as a constant torque load in many cases. Therefore, when excluding ripples generated by performing pulse width modulation (PWM) control, the load unit 300A, including the compressor 315, which is a hermetic compressor, and the inverter 310A, can be regarded as a constant current load.

The inverter 310A includes switching elements 311a to 311f, and freewheeling diodes 312a to 312f each connected in parallel with corresponding one of the switching elements 311a to 311f. Furthermore, the inverter 310A includes a current detecting unit 313a provided between the switching element 311b and the freewheeling diode 312b and a bus, a current detecting unit 313b provided between the switching element 311d and the freewheeling diode 312d and the bus, and a current detecting unit 313c provided between the switching element 311f and the freewheeling diode 312f and the bus. The current detecting units 313a to 313c are configured by shunt resistors. Hereinafter, a leg including the switching elements 311a and 311b, the freewheeling diodes 312a and 312b, and the current detecting unit 313a is referred to as a first leg. A leg including the switching elements 311c and 311d, the freewheeling diodes 312c and 312d, and the current detecting unit 313b is referred to as a second leg. A leg including the switching elements 311e and 311f, the freewheeling diodes 312e and 312f, and the current detecting unit 313c is referred to as a third leg.

The inverter 310A further includes a snubber circuit 320a connected in parallel with the first leg, a snubber circuit 320b connected in parallel with the second leg, and a snubber circuit 320c connected in parallel with the third leg. The snubber circuits 320a to 320c are provided to protect the circuits by reducing surge voltages generated by switching operations of the switching elements 311a to 311f. The first leg is a circuit to be protected by the snubber circuit 320a, the second leg is a circuit to be protected by the snubber circuit 320b, and the third leg is a circuit to be protected by the snubber circuit 320c.

FIG. 5 illustrates a current waveform detected by the current detecting units 313a to 313c. FIG. 5 is a diagram illustrating an example of a waveform of a current flowing through each leg constituting the inverter 310A of the power converting apparatus 1. As illustrated in FIG. 5, the waveform of the current detected by the current detecting units 313a to 313c has a pulse waveform in which an alternating-current waveform is chopped by on/off operations of the switching elements 311a to 311f constituting the inverter 310A. Therefore, when the inverter 310A does not include the snubber circuits 320a to 320c, the current detecting units 313a to 313c are greatly affected by surge and resonance at the time of switching, depending on a wiring method of the switching elements 311a to 311f, or with an increase in a circuit current and a high-frequency driving.

The position of the snubber circuit 320a is in the immediate vicinity of the switching element 311a and the current detecting unit 313a. Details are illustrated in FIG. 6. FIG. 6 is a diagram for describing details of the inverter 310A of the first configuration example included in the power converting apparatus 1 according to the first embodiment. In FIG. 6, reference characters L1a to L3a and L1b to L3b represent parasitic inductance components due to wiring, bonding wires, and the like. Even if an external inductance component of the snubber circuit 320a is large, the snubber circuit 320a can absorb the energy. Therefore, if an internal inductance component of the snubber circuit 320a is small, it is possible to minimally reduce transient vibration components generated by the switching, and accuracy of current detection by the current detecting unit 313a is improved. Therefore, it is sufficient that the internal inductance of the snubber circuit 320a is smaller than the external inductance. The internal inductance is desirably sufficiently smaller than the external inductance, and it is sufficient that a mounting position of the snubber circuit 320a satisfies the following Formula (1). Here, x in Formula (1) corresponds to a suffix in FIG. 6.

$$\begin{matrix}Formula 1 & \\ L {1}_{x} ≫ L {2}_{x} + L {3}_{x} & ( 1 )\end{matrix}$$

That is, it is sufficient that a connection point between the snubber circuit 320a and the circuit to be protected is set to a position where the inductance of a circuit consisting of the snubber circuit 320a and the circuit to be protected is sufficiently smaller than the external inductance.

The circuit configuration of the snubber circuit 320a may be a C snubber of a single capacitor, an RC snubber in which a capacitor and a resistor are connected in series, or any other configuration as long as vibration at the time of switching can be reduced.

The configuration of the snubber circuit 320a has been described, and the snubber circuits 320b and 320c each have a configuration similar thereto.

Here, an effect of a case of the power converting apparatus 1 according to the present embodiment will be described by using a simulation analysis. FIG. 7 is a diagram illustrating an effect obtained by the power converting apparatus 1 according to the first embodiment. Waveforms in FIG. 7(a) represent an inverter element current and a sensor value for a configuration not including the above-described snubber circuits 320a to 320c. The inverter element current is a current flowing through each element included in the inverter. The sensor value is a current value detected by the current detecting unit. Waveforms in FIG. 7(b) represent an inverter element current and a sensor value for a configuration according to the first embodiment, including the above-described snubber circuits 320a to 320c.

Comparing the waveforms in (a) in FIG. 7 and waveforms in (b) in FIG. 7, it is found that surge and resonance superimposed on the inverter element current can be reduced when the configuration according to the first embodiment is applied. When vibrations such as surge and resonance occur, the inverter element current greatly fluctuates every time the switching elements are switched, and the current value detected by the current detecting unit at a given cycle also greatly varies every time the detection is performed. Therefore, as in the sensor value in FIG. 7(a), a waveform on which noise is superimposed is detected by the current detecting unit. Accordingly, there is a concern that the detection accuracy of the current value deteriorates, which adversely affects the control of the switching elements and causes a control failure.

With the configuration according to the present embodiment, that is, with the configuration illustrated in FIGS. 4 and 6 including the snubber circuits 320a to 320c, noise superimposed on the inverter element current can be reduced as illustrated in FIG. 7(b). Therefore, stable sensing can be performed in each current detecting unit, and the current value can be accurately detected even if a shunt resistor having a smaller resistance value is used. This enables cost reduction and downsizing of the apparatus.

Furthermore, the configuration of the load unit 300 illustrated in FIGS. 1 and 2 can be the configuration of a load unit 300B illustrated in FIG. 8. FIG. 8 is a diagram illustrating a second configuration example of the load unit 300 included in the power converting system according to the first embodiment.

The load unit 300B of the second configuration example illustrated in FIG. 8 is obtained by replacing the inverter 310A of the load unit 300A of the first configuration example illustrated in FIG. 4 with an inverter 310B.

The inverter 310B of the load unit 300B includes a current detecting unit 313d instead of the current detecting units 313a to 313c included in the inverter 310A of the load unit 300A. Furthermore, the inverter 310B of the load unit 300B includes a snubber circuit 320d instead of the snubber circuits 320a to 320c included in the inverter 310A of the load unit 300A.

In the inverter 310B, the switching elements 311a and 311b and the freewheeling diodes 312a and 312b constitute the first leg, the switching elements 311c and 311d and the freewheeling diodes 312c and 312d constitute the second leg, and the switching elements 311e and 311f and the freewheeling diodes 312e and 312f constitute the third leg.

The current detecting unit 313d is provided on a direct-current bus on a negative side. The snubber circuit 320d is provided on a direct-current side of the inverter 310B, that is, upstream of the first leg, and between the current detecting unit 313d and the smoothing unit 200, which is not illustrated in FIG. 8. In this configuration, the first leg, the second leg, the third leg, and the current detecting unit 313d form a circuit to be protected by the snubber circuit 320d.

In the inverter 310B illustrated in FIG. 8, the position of the snubber circuit 320d is in the immediate vicinity of the circuit to be protected, that is, in the immediate vicinity of the first leg. Details are illustrated in FIG. 9. FIG. 9 is a diagram for describing details of the inverter of the second configuration example included in the power converting apparatus according to the first embodiment. In FIG. 9, reference characters L1c to L3c and L1d to L3d represent parasitic inductance components due to wiring, bonding wires, and the like. Similarly to the snubber circuits 320a to 320c illustrated in FIG. 4 described above, a mounting position of the snubber circuit 320d is a position that satisfies the above Formula (1). In this way, the effect of the snubber circuit 320d can be maximized, and the current detecting unit 313d can accurately detect the current.

The switching elements 311a to 311f included in each of the inverters 310A and 310B may have a configuration using six discrete elements, or may have a configuration using a module in which six elements are mounted in a single package. Furthermore, when six elements are included in a single package, a configuration may be adopted where the snubber circuits 320a to 320d and the current detecting units 313a to 313d are enclosed in a module under the condition expressed by the above Formula (1).

As described above, the power converting apparatus 1 according to the first embodiment includes the inverter 310 (310A, 310B) including a current detecting unit that is constituted by a shunt resistor that detects a current flowing through a circuit and a snubber circuit. The snubber circuit is connected in parallel with the circuit to be protected that includes the current detecting unit and switching elements through which a current detected by the current detecting unit flows. Furthermore, the snubber circuit is connected in the immediate vicinity of the circuit to be protected. Specifically, a connection point between the snubber circuit and the circuit to be protected is set to a position where the internal inductance of a circuit consisting of the snubber circuit and the circuit to be protected becomes sufficiently smaller than the external inductance. As a result, noise superimposed on the current flowing through the shunt resistor of the current detecting unit can be reduced, and the current value can be accurately detected even if a shunt resistor having a smaller value is used. This enables downsizing of the shunt resistor, and enables cost reduction and downsizing of the apparatus.

### Second Embodiment

FIG. 10 is a diagram illustrating a configuration example of a power converting apparatus 1a according to a second embodiment. Note that constituent elements common to those of the power converting apparatus 1 according to the first embodiment are denoted by the same reference numerals as those of the power converting apparatus 1, and the description thereof is omitted.

The power converting apparatus 1a according to the second embodiment includes a converter 137, the smoothing unit 200, the inverter 310, and a control unit 400a. The converter 137 includes the reactor 120, the rectifying unit 130, a booster unit 140A, and a snubber circuit 150.

The booster unit 140A includes the reactor 141, the switching element 142, the diode 143, and a current detecting unit 144a. The switching element 142 is controlled to be turned on or off by the control unit 400a. The current detecting unit 144a includes a shunt resistor. In the booster unit 140A, the switching element 142 and the current detecting unit 144a are connected in series, and the series circuit consisting of the switching element 142 and the current detecting unit 144a is connected between two direct-current buses that are a bus on the positive side and a bus on the negative side. Specifically, one end of the switching element 142 is connected to the direct-current bus on the positive side, and another end of the switching element 142 is connected to one end of the current detecting unit 144a. Another end of the current detecting unit 144a is connected to the direct-current bus on the negative side. Furthermore, the series circuit, consisting of the switching element 142 and the current detecting unit 144a, and the snubber circuit 150 are connected in parallel.

In the power converting apparatus 1a according to the second embodiment, the converter 137 operates as a power converting unit that generates desired power by switching the switching element 142.

The snubber circuit 150 is provided to protect a circuit by reducing a surge voltage generated by a switching operation of the switching element 142. The circuit consisting of the switching element 142, the diode 143, and the current detecting unit 144a is a circuit to be protected by the snubber circuit 150.

The position of the snubber circuit 150 is in the immediate vicinity of the diode 143 and the current detecting unit 144a. Details are illustrated in FIG. 11. FIG. 11 is a diagram for describing an arrangement of the snubber circuit 150 of the power converting apparatus 1a according to the second embodiment. In FIG. 11, reference characters L1e to L3e and L1f to L3f represent parasitic inductance components due to wiring, bonding wires, and the like. A mounting position of the snubber circuit 150 is a position that satisfies the above Formula (1). In this way, similarly to the power converting apparatus 1 according to the first embodiment, it is possible to reduce transient vibration components generated by the switching of the switching element to the extent possible, and the current detecting unit 144a can accurately detect the current. This enables cost reduction and downsizing of the apparatus.

The circuit configuration of the snubber circuit 150 may be a C snubber of a single capacitor, an RC snubber in which a capacitor and a resistor are connected in series, or any other configuration as long as vibration at the time of switching can be reduced.

Here, an effect of the power converting apparatus 1a according to the present embodiment will be described by using a simulation analysis. FIG. 12 is a diagram illustrating an effect obtained by the power converting apparatus 1a according to the second embodiment. Waveforms in FIG. 12(a) represent a converter element current and a sensor value in a configuration not including the above-described snubber circuit 150. The converter element current is a current flowing through the booster unit 140A. The sensor value is a current value detected by the current detecting unit. Waveforms in FIG. 12(b) represent a converter element current and a sensor value in a configuration according to the second embodiment, including the above-described snubber circuit 150.

Comparing the waveforms in (a) in FIG. 12 and waveforms in (b) in FIG. 12, it is found that surge and resonance superimposed on the converter element current can be reduced when the configuration according to the second embodiment is applied. When vibrations such as surge and resonance occur, the converter element current greatly fluctuates each time the switching element is switched, and the current value detected by the current detecting unit at a given cycle also greatly varies each time the detection is performed. Therefore, as in the sensor value in FIG. 12(a), a waveform on which noise is superimposed is detected by the current detecting unit. Accordingly, there is a concern that the detection accuracy of the current value deteriorates, which adversely affects the control of the switching elements and causes a control failure.

With the configuration according to the present embodiment, that is, with the configuration illustrated in FIGS. 10 and 11 including the snubber circuit 150, noise superimposed on the converter element current can be reduced as illustrated in FIG. 12(b). Therefore, stable sensing can be performed in the current detecting unit 144a, and the current value can be accurately detected even if a shunt resistor having a smaller resistance value is used. This enables cost reduction and downsizing of the apparatus.

The converter 137 of the power converting apparatus 1a illustrated in FIG. 10 can be modified to another circuit configuration. For example, a converter 138 illustrated in FIG. 13 may be used. FIG. 13 is a diagram illustrating another configuration example of the power converting apparatus 1a according to the second embodiment. Constituent elements common to those of the power converting apparatus 1a illustrated in FIG. 10 are denoted by the same reference numerals as those of the power converting apparatus 1a, and the description thereof is omitted.

The converter 138 illustrated in FIG. 13 is obtained by replacing the booster unit 140A of the converter 137 illustrated in FIG. 10 with a booster unit 140B. The booster unit 140B includes the reactor 141, the switching element 142, the diode 143, a current detecting unit 144b, and the snubber circuit 150. The current detecting unit 144b is constituted by a shunt resistor, and is provided on a direct-current bus on the negative side.

In the booster unit 140B, the snubber circuit 150 is disposed in parallel with the smoothing unit 200 not illustrated in FIG. 13. Details are illustrated in FIG. 14. FIG. 14 is a diagram for describing details of the booster unit 140B of another configuration example included in the power converting apparatus 1a according to the second embodiment. In FIG. 14, reference characters L1g to L3g and L1h to L3h represent parasitic inductance components due to wiring, bonding wires, and the like. Similarly to the snubber circuit 150 of the booster unit 140A described above, a mounting position of the snubber circuit 150 of the booster unit 140B is a position that satisfies the above Formula (1). Even in such a configuration, an effect similar to that of the power converting apparatus 1a illustrated in FIG. 10 can be obtained.

The switching element 142 and the diode 143 illustrated in FIGS. 10 and 13 may have a configuration using discrete elements, or may have a configuration using a module in which two elements are mounted in a single package. Furthermore, when two elements are included in a single package, a configuration may be adopted where the snubber circuit 150 and the current detecting unit 144a or 144b are enclosed under the condition expressed by the above Formula (1).

As described above, the power converting apparatus 1a according to the second embodiment includes the booster unit (140A, 140B) including the current detecting unit (144a, 144b) constituted by a shunt resistor that detects a current flowing through a circuit. The snubber circuit 150 is connected in parallel with the circuit to be protected that includes the current detecting unit and a switching element through which a current detected by the current detecting unit flows. Furthermore, the snubber circuit 150 is connected in the immediate vicinity of the circuit to be protected. That is, a connection point between the snubber circuit 150 and the circuit to be protected is set to a position where the internal inductance of a circuit consisting of the snubber circuit 150 and the circuit to be protected becomes sufficiently smaller than the external inductance. As a result, noise superimposed on the current flowing through the shunt resistor of the current detecting unit can be reduced, and the current value can be accurately detected even if a shunt resistor having a smaller resistance value is used. This enables downsizing of the shunt resistor, and enables cost reduction and downsizing of the apparatus.

### Third Embodiment

FIG. 15 is a diagram illustrating a configuration example of a power converting apparatus 1b according to a third embodiment. Note that constituent elements common to those of the power converting apparatus 1 according to the first embodiment are denoted by the same reference numerals as those of the power converting apparatus 1, and the description thereof is omitted.

The power converting apparatus 1b according to the third embodiment includes a converter 139, the smoothing unit 200, the inverter 310, and a control unit 400b. The converter 139 includes the reactor 120 and the rectifying unit 130. The control unit 400b includes a pulsation load compensation unit 410 and a power supply pulsation compensation unit 420. The inverter 310 is the inverter 310A of the load unit 300A illustrated in FIG. 4 or the inverter 310B of the load unit 300B illustrated in FIG. 8, which are described in the first embodiment.

The load unit 300 illustrated in FIGS. 1 and 2 described in the first embodiment is assumed to be a constant torque load having a substantially constant load. For the current output from the smoothing unit 200, it is considered that a constant current load is connected. That is, in order to drive the compressor motor (motor 314) having a substantially constant load, a configuration is adopted in which an output current at which a root mean square value of a three-phase sinusoidal wave current becomes approximately constant is supplied from the inverter to the compressor motor. However, some compressors have a mechanism that generates a periodic rotation variation depending on the type of compressor. In a case of driving such a compressor that causes rotation variation, the load torque periodically varies. Therefore, when the compressor is driven with a constant output current, that is, with a constant torque output, by the use of the inverter 310, speed variation occurs due to a torque difference. There is a characteristic that the speed variation significantly occurs in a low speed range, and the speed variation decreases as the operating point moves to a high speed range. Furthermore, since the amount of the speed variation flows out to the outside, the speed variation is externally observed as vibration, so that it is necessary to add a component as a measure to address the vibration. Therefore, in many cases, a method is adopted in which torque according to load torque fluctuation is given from the inverter 310 to the compressor by causing pulsation torque, that is, an amount of pulsation current, to flow through the compressor separately from the constant current output from the inverter 310, that is, the current corresponding to an amount of the constant torque output. Therefore, by bringing the torque difference close to zero, speed variation of the motor of the compressor can be reduced and vibration can be reduced. As a result, the torque difference between the output torque of the inverter 310 and the load torque becomes close to zero, and the speed variation of the motor of the compressor can be reduced, so that the vibration can be reduced. Such control that reduces vibration of the motor is referred to as pulsation load compensation control.

The pulsation load compensation unit 410 of the control unit 400b performs the above pulsation load compensation control for the inverter 310.

Furthermore, when a commercial power supply is assumed as the alternating-current power supply 110, the current I1 flowing from the converter 139 to the smoothing unit 200 and the inverter 310 is affected by the phase of the alternating-current power supply 110, characteristics of elements mounted upstream and/or downstream of the rectifying unit 130, and the like, but basically has a characteristic including components having a frequency 2n times the power supply frequency (where n is an integer greater than or equal to +1). When the load unit 300 including the inverter 310 and the compressor connected to the inverter 310 is a constant current load, all the pulsatile components of the current I1 flow into the smoothing unit 200 as the current I3, and the load of the smoothing capacitor 210 of the smoothing unit 200 increases. In order to prevent or reduce this phenomenon, the power converting apparatus 1b according to the present embodiment includes the power supply pulsation compensation unit 420.

The power supply pulsation compensation unit 420 extracts components having a frequency 2n times the power supply frequency, included in the current I1, and controls the inverter 310 so that the extracted components are supplied to the inverter 310 as the current I2. This control is referred to as power supply pulsation compensation control. By the power supply pulsation compensation unit 420 controlling the inverter 310 to appropriately pulsate the current I2, the current I3, that is, the current flowing into the smoothing unit 200 and the current flowing out from the smoothing unit 200 can be reduced. That is, it is possible to prevent components having a frequency 2n times the power supply frequency, included in the current I1, from flowing to the smoothing unit 200 as the current I3. By reducing the current I3, it is possible to reduce or prevent deterioration of the smoothing capacitor 210 constituting the smoothing unit 200 and realize downsizing of the smoothing capacitor 210. Note that the power supply pulsation compensation unit 420 analyzes the current I1 detected by the current detecting unit not illustrated in the drawing and extracts components having a frequency 2n times the power supply frequency.

In the power converting apparatus 1b illustrated in FIG. 15, the inverter 310 is controlled so that the components having a frequency 2n times the power supply frequency, included in the current I1, are supplied to the inverter 310 as the current I2, but a configuration illustrated in FIG. 16 may be adopted. FIG. 16 is a diagram illustrating another configuration example of the power converting apparatus according to the third embodiment. A power converting apparatus 1c illustrated in FIG. 16 is obtained by replacing the converter 139 and the control unit 400b of the power converting apparatus 1b illustrated in FIG. 15 with a converter 139c and a control unit 400c. The converter 139c of the power converting apparatus 1c is obtained by adding the booster unit 140 to the converter 139 illustrated in FIG. 15. The booster unit 140 has a configuration similar to that of the booster unit 140A of the converter 137 illustrated in FIG. 10 or the booster unit 140B of the converter 138 illustrated in FIG. 13. The control unit 400c includes the pulsation load compensation unit 410 and a power supply pulsation compensation unit 430.

In the above power converting apparatus 1b, the power supply pulsation compensation unit 420 controls switching elements constituting the inverter 310 so that the components having a frequency 2n times the power supply frequency, included in the current I1, are supplied to the inverter 310 as the current I2. On the other hand, in the power converting apparatus 1c, the power supply pulsation compensation unit 430 controls the switching element constituting the booster unit 140 of the converter 139c so that components having a frequency 2n times the power supply frequency, included in the current I1, are reduced and the components having a frequency 2n times the power supply frequency are prevented from flowing into the smoothing unit 200 as the current I3. The power supply pulsation compensation unit 430 turns on or off the switching element included in the booster unit 140 of the converter 139c so as to pulsate the current flowing from the alternating-current power supply 110 to the converter 139c within a range allowed by a standard or the like, and reduces the current I3, that is, the current flowing into the smoothing unit 200 and the current flowing out from the smoothing unit 200.

When such an operation is performed, current values of the inverter 310 and the converter 139c do not form clean sinusoidal waves, but form pulsatile waveforms including various frequency components. Accordingly, a waveform in which pulsation is superimposed on the current I1 and the current I2 is also generated.

In the power converting apparatus 1 according to the first embodiment, it is sufficient that the resistance value of the shunt resistor used for current detection is selected in consideration of only the current of the constant current load, but in the power converting apparatus 1b illustrated in FIG. 15, it is necessary to select the resistance value of the shunt resistor in consideration of pulsatile components.

The value of the shunt resistor is obtained from the following two points. The first is an allowable loss, and the second is an allowable detection value on the controller side. When the value of the shunt resistor is R, and the value of the current flowing through the shunt resistor is I, allowable loss Pᵣ is Pᵣ=R·I². Therefore, when the load unit 300 consisting of the inverter 310 connected to the smoothing unit 200 of the power converting apparatus 1b and the compressor connected to the inverter 310 can be regarded as a constant current load, the value of the shunt resistor is selected in consideration of the variation in the current value due to the control of the inverter 310 by the pulsation load compensation unit 410 and the power supply pulsation compensation unit 420, in addition to the current value flowing through the load unit 300.

The root mean square value of the current necessary for the computation of the allowable loss is obtained as follows. Note that, normally, a current includes ripples generated by performing PWM control by an inverter or a chopper circuit, but the ripples are considered to be averaged here. When the inverter 310 and the compressor connected to the inverter 310 can be regarded as a constant current load unit, a current value Iᵢₙᵥ flowing through the load is expressed by Formula (2), a current value Iₘ generated by the pulsation load compensation unit 410 controlling the inverter 310 is expressed by Formula (3), and a current value I_{acn} generated by the power supply pulsation compensation unit 420 controlling the inverter 310 is expressed by Formula (4).

$$\begin{matrix}Formula 2 & \\ {I}_{inv} = {I}_{a} & ( 2 )\end{matrix}$$

$$\begin{matrix}Formula 3 & \\ {I}_{m} = {I}_{b} \cdot sin ( {ω}_{m} t + {φ}_{m} ) & ( 3 )\end{matrix}$$

$$\begin{matrix}Formula 4 & \\ {I}_{acn} = {I}_{cn} \cdot sin ( 2 n \cdot {ω}_{a c} t + {φ}_{a c} ) & ( 4 )\end{matrix}$$

Since Iᵢₙᵥ is a current of the constant current load, Iᵢₙᵥ is expressed by a direct current. Since Iₘ is a vibration component generated in the compressor, Iₘ is expressed by an alternating current. In Formula (3), I_{b} represents a maximum value of Iₘ, ωₘ represents an angular frequency of vibration, t represents time, and φₘ represents a phase. Since I_{acn} is a pulsatile component of the power supply, I_{acn} is expressed by an alternating current. In Formula (4), I_{cn} represents a maximum value of I_{acn}, ω_{ac} represents an angular frequency of pulsation, t represents time, φ_{ac} represents a phase, and n represents an integer greater than or equal to +1.

A combined root mean square value I_{total_rms} of these current values is expressed by Formula (5). The power supply pulsation compensation unit 420 may compensate one or a plurality of frequency components, and terms corresponding to the number of frequency components (value of n) are added to calculate the combined root mean square value I_{total_rms}. Furthermore, the amount to be compensated by the pulsation load compensation unit 410 and the power supply pulsation compensation unit 420 can be freely changed. The compensation amount by the pulsation load compensation unit 410 is determined by a constant k, and the compensation amount by the power supply pulsation compensation unit 420 is determined by a constant jₙ.

$$\begin{matrix}Formula 5 & \\ {I}_{total \_ rms} = \sqrt{{I}_{inv}^{2} + k \cdot {I}_{m}^{2} + {j}_{1} \cdot {I}_{a c 1}^{2} + … + {j}_{n} \cdot {I}_{acn}^{2}} & ( 5 )\end{matrix}$$

When allowable power of the shunt resistor is P, a relational expression between allowable power P and a resistance value R is expressed by Formula (6). According to Formula (6), the value of the shunt resistor is limited according to the magnitudes of the vibration component and the pulsatile component to be compensated.

$$\begin{matrix}Formula 6 & \\ R \leq \frac{P}{{I}_{total \_ rms}} & ( 6 )\end{matrix}$$

According to Formula (6), when the amount of allowable power is equivalent to that of the shunt resistor constituting an inverter of a power converting apparatus configured not to perform pulsation load compensation control and power supply pulsation compensation control, the value of the shunt resistor constituting the inverter 310 of the power converting apparatus 1b illustrated in FIG. 15 is smaller.

When the current detection is performed by using the shunt resistor selected as described above having a small value, the current can be accurately detected even if the value of the shunt resistor is small by combining the snubber circuits described in the first and second embodiments, which enables cost reduction and downsizing of the apparatus.

Furthermore, the maximum value of the shunt resistor is determined by Formula (6), but the minimum value is not determined. As the value of the shunt resistor decreases, the value of the detection current decreases. Therefore, when the detection current takes a minimum value, the detection current needs to be greater than or equal to a value detectable by a control circuit constituting the control unit that performs control by using a detection value. In the power converting apparatus 1b illustrated in FIG. 15, it is necessary to detect an alternating-current waveform in which components having various frequencies are mixed. In view of the above, a minimum value I_{total_min} of the combined pulsatile waveform of the above Formulas (2) to (4) is computed, and the value of the minimum value I_{total_min} is assumed to be within a range of a detection error x [%] of the control circuit. A relational expression is expressed in Formula (7). Vₑᵣᵣₒᵣ₋ₓ in Formula (7) is a sensor value by use of which the detection error of the control circuit becomes x [%]. By selecting the minimum value of the shunt resistor so as to satisfy Formula (7), desired performance, that is, a desired detection error, can be realized even if the value of the shunt resistor is reduced. The detection error x [%] is optionally set on the basis of the performance of the control circuit to be used, the request of the user side, and the like.

$$\begin{matrix}Formula 7 & \\ R \geq \frac{{V}_{error - x}}{{I}_{total \_ min}} & ( 7 )\end{matrix}$$

As described above, by using the shunt resistor having the value obtained from the above Formulae (6) and (7), appropriate current detection is possible also in the power converting apparatus 1b illustrated in FIG. 15.

### Fourth Embodiment

FIG. 17 is a diagram illustrating a configuration example of a power converting apparatus 1d according to a fourth embodiment. Note that constituent elements common to those of the power converting apparatus 1 according to the first embodiment are denoted by the same reference numerals as those of the power converting apparatus 1, and the description thereof is omitted.

The power converting apparatus 1d according to the fourth embodiment includes a converter 139d, the smoothing unit 200, an inverter 310d, and a control unit 400d. The converter 139d includes the reactor 120 and a rectifying unit 130d. The rectifying unit 130d is obtained by adding a substrate temperature detecting unit 501 to the rectifying unit 130 included in the power converting apparatus 1 described in the first embodiment. The inverter 310d is obtained by adding a substrate temperature detecting unit 502 to the inverter 310A of the load unit 300A illustrated in FIG. 4 or the inverter 310B of the load unit 300B illustrated in FIG. 8, which are described in the first embodiment. The substrate temperature detecting unit 501 detects a temperature of a substrate on which a shunt resistor constituting a current detecting unit provided in the converter 139d is mounted. Note that the substrate temperature detecting unit 501 is provided inside the rectifying unit 130d in FIG. 17, but location of the substrate temperature detecting unit 501 does not matter as long as the substrate temperature detecting unit 501 can detect the temperature of the substrate on which the shunt resistor is mounted. The substrate temperature detecting unit 502 detects a temperature of a substrate on which a shunt resistor constituting a current detecting unit provided in the inverter 310d is mounted. Each of the substrate temperature detecting units 501 and 502 is constituted by a temperature sensor, for example.

The control unit 400d includes a pulsation load compensation unit 411 and a power supply pulsation compensation unit 421. The pulsation load compensation unit 411 performs pulsation load compensation control similar to that of the pulsation load compensation unit 410 constituting the control unit 400b of the power converting apparatus 1b according to the third embodiment, but changes a part of the control operation according to the temperatures detected by the substrate temperature detecting units 501 and 502. Furthermore, the power supply pulsation compensation unit 421 performs power supply pulsation compensation control similar to that of the power supply pulsation compensation unit 420 constituting the control unit 400b of the power converting apparatus 1b according to the third embodiment, but changes a part of the control operation according to the temperatures detected by the substrate temperature detecting units 501 and 502.

If the pulsation load compensation control and the power supply pulsation compensation control are performed at all times and the current on which pulsatile components are superimposed is caused to flow at all times, there is a possibility that heat generated in the shunt resistor exceeds an allowable value that is a predetermined threshold due to the temperature of the surrounding environment and the heat transferred from the surrounding elements. Since a fault of the shunt resistor means a circuit control failure, it is important to take measures to avoid the fault.

As described above, the loss Pᵣ generated in a shunt resistor is Pᵣ=R·I², and is obtained by computing the root mean square value of the current detected by the shunt resistor and multiplying the root mean square value by the resistance value of the shunt resistor. Furthermore, heat generation ΔT[° C.] is obtained by using thermal resistance characteristics of the shunt resistor and a loss. Since the thermal resistance characteristics are disclosed in a specification or the like provided by a manufacturer, it is sufficient to use the disclosed thermal resistance characteristics. A value is obtained with reference to temperatures detected by the substrate temperature detecting units 501 and 502, and a value obtained by adding ΔT thereto is a temperature of the shunt resistor, and when the temperature becomes greater than or equal to the allowable value, the power converting apparatus 1d transitions into protection operation for the shunt resistor.

As the protection operation for the shunt resistor performed when the temperature of the shunt resistor becomes greater than or equal to the allowable value, reduction of the compensation amount by pulsation load compensation control and power supply pulsation compensation control can be named, for example. When the temperature of the shunt resistor becomes greater than or equal to the allowable value, the pulsation load compensation unit 411 and the power supply pulsation compensation unit 421 reduce the pulsatile components to be superimposed on the circuit current by the pulsation load compensation control and the power supply pulsation compensation control so as to reduce the current flowing through the circuit and prevent or reduce an increase in the temperature of the shunt resistor. As a result, the risk of the shunt resistor failing due to heat can be reduced.

Furthermore, as another protection operation, when the temperature of the shunt resistor becomes greater than or equal to the allowable value, the pulsation load compensation unit 411 and the power supply pulsation compensation unit 421 may control the inverter 310d to reduce the current I2, which is an input current to the inverter circuit, so as to reduce the current flowing through the shunt resistor and prevent or reduce an increase in the temperature of the shunt resistor.

Furthermore, as another protection operation, the temperature of the substrate on which the shunt resistor is mounted may be reduced by increasing an air volume of a fan cooling the power converting apparatus 1d. The control to increase the air volume of the fan may be performed by the control unit 400d or may be performed by another control unit not illustrated in the drawing.

Furthermore, when the temperature of the shunt resistor becomes greater than or equal to the allowable value, a configuration may be adopted in which any one of the above protection operations is performed or two or more of the above protection operations are performed in combination.

Note that when the rectifying unit 130d and the inverter 310d are disposed on the same substrate and are at positions where both are in contact with each other, it is not necessary to include both of the substrate temperature detecting units 501 and 502, and it is sufficient to include either one. Furthermore, a configuration may be adopted in which the temperature of the shunt resistor is directly measured instead of measuring the temperature of the substrate. In this case, computation for temperature estimation of the shunt resistor, described above, is unnecessary, and the risk of a failure of the shunt resistor may be reduced by executing the above protection operations according to the magnitude of the detection temperature.

The power converting apparatus 1d may have a configuration including the booster unit 140A illustrated in FIG. 10 or the booster unit 140B illustrated in FIG. 13, which are described in the second embodiment.

As described above, the power converting apparatus 1d according to the present embodiment includes the substrate temperature detecting units 501 and 502, and performs control to protect the shunt resistor according to the temperature of the substrate. Specifically, the power converting apparatus 1d obtains the temperatures of the shunt resistors on the basis of the substrate temperatures detected by the substrate temperature detecting unit 501 and 502. When the temperature of the shunt resistor is greater than or equal to the predetermined allowable value, the power converting apparatus 1d starts the protection operation to reduce or prevent an increase in the temperature of the shunt resistor. As a result, the risk of the shunt resistor failing due to heat can be reduced. Note that among the protection operations described above, the protection operation in which the air volume of the fan cooling the power converting apparatus 1d is increased can also be applied to a power converting apparatus that does not perform the pulsation load compensation control and the power supply pulsation compensation control. That is, the protection operation can be applied to any power converting apparatus described in the first to third embodiments.

### Fifth Embodiment

FIG. 18 is a diagram illustrating a configuration example of a power converting apparatus 1e according to a fifth embodiment. Note that constituent elements common to those of the power converting apparatus 1 according to the first embodiment are denoted by the same reference numerals as those of the power converting apparatus 1, and the description thereof is omitted.

The power converting apparatus 1e according to the fifth embodiment is obtained by replacing the control unit 400 of the power converting apparatus 1 according to the first embodiment illustrated in FIG. 2 with a control unit 400e. The control unit 400e includes a shunt current detecting unit 440. Note that the inverter 310 is the inverter 310A of the load unit 300A illustrated in FIG. 4 or the inverter 310B of the load unit 300B illustrated in FIG. 8, which are described in the first embodiment.

The shunt current detecting unit 440 detects currents flowing through the shunt resistors constituting the current detecting units 313a to 313c included in the inverter 310 or the shunt resistor constituting the current detecting unit 313d.

As described in the first embodiment, the current flowing through the shunt resistor is a current forming a pulsed waveform generated by the switching of the switching elements. The waveform of the pulsed current includes ringing of turning on or off of the switching elements and hence, a value within a pulsation range of the ringing is detected depending on the detection timing. In this case, the detection value is not an accurate value, and normal control is difficult. By disposing a shunt resistor inside the snubber circuit as in the power converting apparatus 1 according to the first embodiment, it is possible to reduce the ringing. However, if the current detection is not performed at the correct timing, the accuracy of the current detection is insufficient.

Therefore, the control unit 400e of the power converting apparatus 1e according to the present embodiment includes the shunt current detecting unit 440 for detecting a current flowing through the shunt resistor at the correct timing.

Details of the shunt current detecting unit 440 will be described. FIG. 19 is a diagram illustrating an example of a processing block configuration of the shunt current detecting unit 440 included in the power converting apparatus 1e according to the fifth embodiment.

The shunt current detecting unit 440 includes a sawtooth wave generation unit 441, a comparator unit 442, and a current acquisition unit 443.

A carrier wave used for generating a control signal for driving switching elements constituting the inverter 310 is input to the sawtooth wave generation unit 441. The sawtooth wave generation unit 441 generates a sawtooth wave having an amplitude of 1 synchronized with the input carrier wave, and outputs the sawtooth wave to the comparator unit 442.

The sawtooth wave generated by the sawtooth wave generation unit 441 and a direct-current signal having a value of 0.5 are input to the comparator unit 442. The comparator unit 442 operates as a rectangular-wave pulse generation unit, generates a rectangular-wave pulse having a duty ratio of 0.5 on the basis of the input sawtooth wave and direct-current signal, and outputs the rectangular-wave pulse to the current acquisition unit 443.

A pulse wave generated by the comparator unit 442 is input to the current acquisition unit 443, and the current flowing through the shunt resistor is input to the current acquisition unit 443 as a shunt resistor current. The current acquisition unit 443 acquires the shunt resistor current with the rise of the pulse wave input from the comparator unit 442 as a trigger, and outputs the shunt resistor current as a detection current.

Note that the examples in FIGS. 18 and 19 illustrate a configuration in which the current detecting unit provided in the inverter 310 is constituted by the shunt resistor only, and the control unit 400e includes the shunt current detecting unit 440 that acquires a current flowing through the shunt resistor at an appropriate timing. However, the shunt current detecting unit 440 may be provided in the inverter 310.

Furthermore, when a shunt resistor is provided also in the converter 135 as a current detecting unit, the shunt current detecting unit 440 acquires a shunt resistor current from the current detecting unit provided in the converter 135 by a similar method.

FIG. 20 is a diagram illustrating examples of operation waveforms of the shunt current detecting unit 440. The operation waveforms in FIG. 20 represent, in order from the top, a pulse wave generated by the comparator unit 442, a shunt resistor current input to the current acquisition unit 443, and a detection current acquired and output by the current acquisition unit 443.

As described above, the shunt resistor current includes not a little ringing component at the time of switching. However, if the ringing can be reduced to some extent by the snubber circuit, the value after the ringing subsides can be detected by detecting a median value of the pulsed current of the shunt resistor. By detecting the shunt resistor current at the timing of the rise of the pulse wave generated from the sawtooth wave synchronized with the carrier wave as in the shunt current detecting unit 440 of the present embodiment, the median value of each pulse of the pulsed shunt resistor current can be detected as illustrated in FIG. 20. Furthermore, the shunt current detecting unit 440 generates a pulse wave by using a carrier wave used for generating a control signal of an element. Therefore, the shunt current detecting unit 440 can be easily implemented, and the control is not complicated.

Note that the case has been described in which the control unit 400 of the power converting apparatus 1 according to the first embodiment includes the shunt current detecting unit 440, but the control unit of the power converting apparatus according to the second to fourth embodiments can have a configuration including the shunt current detecting unit 440.

As described above, the control unit 400e of the power converting apparatus 1e according to the present embodiment includes the shunt current detecting unit 440 that detects a current flowing through the shunt resistor at the timing based on a carrier wave used for generating a control signal of a switching element. Therefore, the current flowing through the shunt resistor can be detected while avoiding the timing at which a large amount of ringing components generated along with the on/off operation of the switching element are included.

Next, a hardware configuration of each control unit (control unit 400, 400a, 400b, 400c, 400d, 400e) included in each power converting apparatus (power converting apparatus 1, 1a, 1b, 1c, 1d, 1e) described in each embodiment will be described. Note that hardware configurations of the respective control units are similar to each other.

FIG. 21 is a diagram illustrating an example of a hardware configuration that implements the control unit included in the power converting apparatus. The control unit of the power converting apparatus is implemented by, for example, a processor 91 and a memory 92 illustrated in FIG. 21.

The processor 91 is a central processing unit (CPU, also referred to as a central processing device, a processing device, a computing device, a microprocessor, a microcomputer, a processor, or a digital signal processor (DSP)). The memory 92 is a random access memory (RAM), a read only memory (ROM), a flash memory, an erasable programmable read only memory (EPROM), an electrically erasable programmable read only memory (EEPROM (registered trademark), or the like.

The memory 92 stores a program for operating as a control unit of the power converting apparatus. The control unit of the power converting apparatus is realized by the processor 91 reading and executing the program stored in the memory 92. The program described above stored in the memory 92 may have a form provided to a user or the like in a state of being written in a storage medium such as a compact disc (CD)-ROM or a digital versatile disc (DVD)-ROM, for example, or a form provided via a network.

Note that the control unit can be realized by a dedicated processing circuit, for example, a single circuit, a composite circuit, an application specific integrated circuit (ASIC), a field programmable gate array (FPGA), or a circuit obtained by combining these circuits.

### Sixth Embodiment

In the present embodiment, an apparatus that can be realized by applying each of the power converting apparatuses described in the first to fifth embodiments will be described. As an example, a refrigeration-cycle application device using the power converting apparatus 1 described in the first embodiment will be described.

FIG. 22 is a diagram illustrating a configuration example of a refrigeration-cycle application device 900 according to a sixth embodiment. The refrigeration-cycle application device 900 according to the sixth embodiment includes a motor drive apparatus 10 to which the power converting apparatus 1 described in the first embodiment is applied.

Furthermore, the refrigeration-cycle application device 900 includes a refrigeration cycle having a configuration in which a four-way valve 902, a compressor 903, a heat exchanger 906, an expansion valve 908, and a heat exchanger 910 are mounted via a refrigerant pipe 912. The compressor 903 corresponds to the compressor 315 illustrated in FIG. 2, or the like.

A compressor mechanism 904 that compresses a refrigerant circulating inside the refrigerant pipe 912 and a motor 905 that operates the compressor mechanism 904 are provided in the compressor 903. The motor 905 corresponds to the motor 314 illustrated in FIG. 4.

The refrigeration-cycle application device 900 having such a configuration can be utilized for, for example, an air conditioner, a heat pump water heater, a refrigerator, a freezer, and the like.

The configurations described in the above embodiments are just examples and can be combined with other known techniques. The embodiments can be combined with each other and the configurations can be partially omitted or changed without departing from the gist.

1. A power converting apparatus comprising:
a power converting device comprising a switching element and generating desired power by switching the switching element;
a current detector detecting a current flowing through the power converting device; and
a snubber circuit reducing a surge voltage generated by a switching operation of the switching element, wherein
a circuit comprising the switching element and the current detector is a circuit to be protected by the snubber circuit, and the snubber circuit and the circuit to be protected are connected such that an internal inductance of a circuit consisting of the snubber circuit and the circuit to be protected is smaller than an external inductance, wherein
the current detector comprises a shunt resistor,
the power converting device is configured to output or input a direct current on which a plurality of pulsatile components having different frequencies with each other are superimposed,
when a value of the shunt resistor is R, allowable power of the shunt resistor is P, a root mean square value of the direct current is I_{total_rms}, a minimum value of the direct current is I_{total_min}, a current detection value at which a detection error of a current detected by the current detector is x [%] is Vₑᵣᵣₒᵣ₋ₓ,
a value R of the shunt resistor is set to satisfy Formula (1) below.
$$\frac{{V}_{error - x}}{{I}_{total \_ min}} \leq R \leq \frac{P}{{I}_{total \_ rms}} \qquad ( 1 )$$

2. The power converting apparatus according to claim 1, wherein
the power converting device is an inverter,
the inverter comprises a first leg, a second leg, and a third leg, each of which includes the switching element,
each of the first leg, the second leg, and the third leg includes the current detector connected in series with the switching element, and
the snubber circuit is individually connected to each of the first leg, the second leg, and the third leg.

3. The power converting apparatus according to claim 1, wherein
the power converting device is an inverter,
the current detector is provided on a direct-current bus between a smoothing circuit smoothing direct-current power supplied to the inverter and the inverter, and
the snubber circuit is connected between direct-current buses between the smoothing circuit and the current detector.

4. The power converting apparatus according to claim 1, wherein
the power converting device is a converter,
the converter comprises a booster circuit comprising the switching element,
the current detector is provided between the switching element and a direct-current bus, and
the snubber circuit is connected between direct-current buses between a smoothing circuit smoothing direct-current power generated by the converter and the booster circuit.

5. The power converting apparatus according to claim 1, wherein
the power converting device is a converter,
the converter includes a booster circuit including the switching element,
the current detector is provided on a direct-current bus between the booster circuit and a smoothing circuit smoothing direct-current power generated by the converter, and
the snubber circuit is connected between direct-current buses between the smoothing circuit and the current detector.

6. (canceled)

7. The power converting apparatus according to claim 1, comprising
a substrate temperature detector detecting a temperature of a substrate on which the current detector is mounted, wherein
when a temperature of the current detector obtained by use of a temperature detected by the substrate temperature detector is greater than or equal to a predetermined threshold, a protection operation to reduce or prevent an increase in the temperature of the current detector is started.

8. A power converting apparatus comprising:
a power converting device comprising a switching element and generating desired power by switching the switching element;
a current detector detecting a current flowing through the power converting device; and
a snubber circuit reducing a surge voltage generated by a switching operation of the switching element,
a sawtooth wave generator generating a sawtooth wave synchronized with a carrier wave used for generating a control signal of the switching element;
a rectangular-wave pulse generator generating a rectangular-wave pulse having a duty ratio of 0.5 on a basis of the sawtooth wave; and
a current acquisition circuit acquiring a current flowing through the current unit detector at a timing of a rise of the rectangular-wave pulse, wherein
a circuit comprising the switching element and the current detector is a circuit to be protected by the snubber circuit, and the snubber circuit and the circuit to be protected are connected such that an internal inductance of a circuit consisting of the snubber circuit and the circuit to be protected is smaller than an external inductance, and
an operation of the power converting device is controlled on a basis of a value of the current acquired by the current acquisition circuit.

9. A motor drive apparatus, comprising the power converting apparatus according to claim 1.

10. A refrigeration-cycle application device, comprising the power converting apparatus according to claim 1.

11. The power converting apparatus according to claim 8, wherein
the power converting device is an inverter,
the inverter comprises a first leg, a second leg, and a third leg, each of which includes the switching element,
each of the first leg, the second leg, and the third leg includes the current detector connected in series with the switching element, and
the snubber circuit is individually connected to each of the first leg, the second leg, and the third leg.

12. The power converting apparatus according to claim 8, wherein
the power converting device is an inverter,
the current detector is provided on a direct-current bus between a smoothing circuit smoothing direct-current power supplied to the inverter and the inverter, and
the snubber circuit is connected between direct-current buses between the smoothing circuit and the current detector.

13. The power converting apparatus according to claim 8, wherein
the power converting device is a converter,
the converter comprises a booster circuit comprising the switching element,
the current detector is provided between the switching element and a direct-current bus, and
the snubber circuit is connected between direct-current buses between a smoothing circuit smoothing direct-current power generated by the converter and the booster circuit.

14. The power converting apparatus according to claim 8, wherein
the power converting device is a converter,
the converter includes a booster circuit including the switching element,
the current detector is provided on a direct-current bus between the booster circuit and a smoothing circuit smoothing direct-current power generated by the converter, and
the snubber circuit is connected between direct-current buses between the smoothing circuit and the current detector.

15. The power converting apparatus according to claim 8, comprising
a substrate temperature detector detecting a temperature of a substrate on which the current detector is mounted, wherein
when a temperature of the current detector obtained by use of a temperature detected by the substrate temperature detector is greater than or equal to a predetermined threshold, a protection operation to reduce or prevent an increase in the temperature of the current detector is started.

16. A motor drive apparatus, comprising the power converting apparatus according to claim 8.

17. A refrigeration-cycle application device, comprising the power converting apparatus according to claim 8.
